(19) United States
(12) Patent Application Publication
(10) Pub. No.: US 2015/0049293 A1
(43) Pub. Date: Feb. 19, 2015

(54) Decal for eyeglasses

(71) Applicant: Donald Eugene Hodgson, Erie, CO (US)

(72) Inventor: Donald Eugene Hodgson, Erie, CO (US)

(21) Appl. No.: 13/987,735

(22) Filed: Aug. 16, 2013

(51) Int. Cl. G02C 11/02

(52) U.S. Cl. CPC G02C 11/02
USPC 351/52

(57) ABSTRACT

A decal or transparent sticker that can be applied to eyeglasses and removed completely from the eyeglasses when desired.

### FIELD OF THE INVENTION

This invention is directed to novelty eyeglasses for advertising, sports, holidays, fundraisers and so on.

### BACKGROUND OF THE INVENTION

There have been no suggestions in prior art to a novelty eyeglasses as this.

### BRIEF DESCRIPTION OF THE INVENTION

This invention relates to eyeglasses, where a form of art is made from a transparent film into a decal or sticker and is attached to the lens of the eyeglasses by glue or static cling. The decal can be removed and reapplied at anytime.

### DESCRIPTION OF THE DRAWINGS

FIG. 1 is a front view of the glasses with decals on lens.

### DETAILED DESCRIPTION OF THE INVENTION

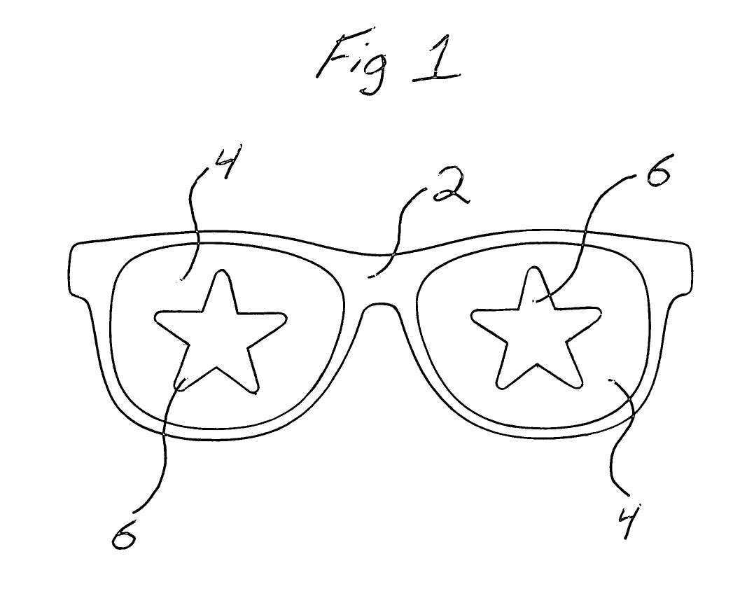

In FIG. 1 there is illustrated a pair of eyeglasses 2 with lens 4 located on lens 4 are decals 6.

What is claimed:

1. A transparent decal for eyeglasses that can be made into any shape and attached to lens by static cling and can be removed and replaced at anytime.

2. A transparent decal wherein the decal is attached to the lens with adhesive.

3. A transparent decal wherein the decal is attached to the lens with cohesive.
